(19) United States
(12) Patent Application Publication
(10) Pub. No.: US 2010/0170353 A1
(43) Pub. Date: Jul. 8, 2010

(54) PUMPING UNIT

(75) Inventors: David Bruce Mattison, Orrville, OH (US); James J. Paumier, Canton, OH (US)

Correspondence Address: Edward T. Kennedy, Esq.;Krugliak, Wilkins, Griffiths & Dougherty Co., LPA, 4775 Munson Street NW, Canton, OH, 44718, US

(73) Assignee: NEW RIVER EQUIPMENT CORP., NORTH CANTON, OH (US)

(21) Appl. No.: 12/498,140

(22) Filed: Jul. 6, 2009

Related U.S. Application Data
(60) Provisional application No. 61/078,620, filed on Jul. 7, 2008.

(51) Int. Cl. F16H 21/22

(52) U.S. Cl. 74/41

(57) ABSTRACT

A pumping unit that removes fluid from a well includes a base disposed on a foundation adjacent the well. A group of support posts is mounted on the base and extends upwardly to a center bearing, and is connected to the center bearing. A walking beam is pivotally mounted on the bearing. A Pitman arm is pivotally connected to the walking beam rearwardly of the center bearing, and extends downwardly to a crank assembly. The crank assembly is mounted on the base centrally beneath the Pitman arm, and is pivotally connected to the Pitman arm. A gear reducer is mounted on the side of the crank assembly, and a drive unit is mounted on the base and is connected to the gear reducer. Actuation of the drive unit actuates movement of the gear reducer, crank assembly, Pitman arm, and the walking beam to pump the fluid from the well.

### CROSS-REFERENCE TO RELATED APPLICATIONS

This application claims the benefit of U.S. Provisional Patent Application Ser. No. 61/078,620, which was filed on Jul. 7, 2008.

### BACKGROUND OF THE INVENTION

1. Technical Field

The invention relates generally to the art of pumping units for oil and gas wells. More particularly, the invention relates to pumping units for oil and gas wells that have relatively moderate or modest production volume, in which the pumping unit is the above-ground drive mechanism for a reciprocating piston pump that is installed in the borehole of the well. Still more particularly, the pumping unit of the present invention provides an efficient, balanced crank arm design, a planetary gear reduction system mounted on the side of the crank arm design, and other features that improve the performance of the pumping unit, increase the safety of the pumping unit, and decrease the costs associated with the pumping unit.

2. Background Art

In order to mechanically remove fluid from an oil and/or gas well, a string of tubing is lowered into the borehole of the well to a selected depth. Then, a string of rods, which has a reciprocating piston pump attached to its bottom end, is lowered into the tubing until the pump is seated at the bottom of the tubing in the well. To lift the fluid from the bottom of the well to the surface, the string of rods is stroked or moved up and down by an above-ground pumping unit, which actuates the reciprocating piston pump down in the well. In this manner, the piston pump thus pumps the fluid to the surface.

The above-ground pumping employs what is known in the art as a walking beam. More particularly, the forward end of a beam is connected to the above-ground end of the string of rods, while the rearward end of the beam is connected to adjustable weights that act as a counterbalance to the weight of the string of rods, and a pivot point is located at the fulcrum of the beam. The beam oscillates about the pivot point, thus producing the reciprocating motion that moves the strings of rods up and down to actuate the piston pump down in the well.

To facilitate the connection of the forward end of the beam to the string of rods in the well, a curved metal box structure, known in the art as a horse head, is attached to the forward end of the walking beam. A metal cable, which is known in the art as a wireline, is attached to the horse head and is in turn connected to the string of rods. The wireline follows the curve of the horse head as the forward end of the walking beam raises and lowers, which enables the pumping unit to create a completely vertical stroke of the string of rods in the well.

A drive unit drives the oscillation of the walking beam about the pivot point by turning a pair of crank arms, which are connected to a pair of mechanical links that are known in the art as Pitman arms. The Pitman arms extend to an equalizer bar, which in turn is connected to a bearing that attaches to the walking beam rearwardly of the pivot point. The drive unit typically is an electric motor or an internal combustion engine, and is referred to herein as a motor for the purpose of convenience. Because the output shaft of the motor typically rotates at a very high number of revolutions-per-minute (rpm), it is connected by belts and sheaves to a gear reducer, which in turn is connected to the crank arms. The gear reducer reduces the number of rpm and provides the torque capacity to enable the walking beam to oscillate as desired, particularly in light of the considerable weight borne by the beam.

This four-bar lever system (two crank arms and two Pitman arms) converts rotational motion at the motor/crank arms to reciprocating motion at the forward end of the walking beam, which is connected to the string of rods. Such a configuration, which is known in the art as a Beam Balanced Pumping Unit, is a Class 1 Lever System, and may be operated in either direction of rotation of the motor and/or crank arms.

Prior art pumping units, while being satisfactory for their intended function, possess certain disadvantages. For example, in the prior art, the gear reducer is located directly beneath the rearward end of the walking beam. The gear reducer thus supports the walking beam and the beam weights. As a result, when the gear reducer needs to be repaired or removed, specially trained mechanics must first secure the rod string in the well with heavy-duty rod clamps. Next, the walking beam with the beam weights must be secured in a level position by chaining each end of the walking beam to the base or other components of the pumping unit. At the connection of each crank arm to its respective Pitman arm, there is a crank pin bearing assembly that must be removed, and the Pitman arms must either be secured to a support post or removed from the walking beam. Finally, both crank arms must be removed from the gear reducer, which requires a special puller apparatus. All of these components are very heavy and require the use of a lifting device or crane to remove.

Once all of these components are secured and/or removed, the mechanics are able to remove the gear reducer, which also requires a crane. However, because the walking beam and beam weights are directly above the gear reducer, it is difficult to hoist the gear reducer up due to interference between the hoist mechanism and the walking beam. Alternatively, the mechanics may choose to repair the gear reducer while it is still mounted on the pumping unit. In either case, the mechanics find themselves in a position that may be dangerous due to its location directly under the heavy walking beam and beam weights. The mechanics must use care to ensure that the chains and/or binders securing the walking beam in place are not accidentally or inadvertently released, since the beam and weights might undesirably swing down toward the gear reducer. As a result, there is a need in the art for a pumping unit with a crank assembly that can be positively locked in position to secure the walking beam, beam weights, Pitman arms, crank arms, and rod string without any disassembly of these components. Furthermore, there is a need in the art for a pumping unit that has an independent gear reducer which is not mounted below the walking beam.

Other disadvantages of prior art pumping units are associated with the type of gear reducer that has been used in the prior art. More particularly, the prior art gear reducer is an expensive, custom-built parallel gearbox that is mounted on the base of the pumping unit. This gearbox has two distinct functions. The first one, as mentioned above, is to reduce the speed and increase the torque of the pumping unit motor. The second function is to support the crank arms, which in combination with the Pitman arms, move the rearward end of the walking beam and the beam weights up and down. This second function requires the gearbox to be custom built as a very heavy-duty unit, with large bearings on the output shafts to be able to support the heavy load of the walking beam and beam weights. Such a construction makes the gearbox very expensive. Therefore, there is a need in the art for a pumping unit that includes a crank assembly which supports the weight of the walking beam and beam weights, and for a pumping unit that has an inexpensive gear reducer which is independent of the heavy loads of the walking beam and the beam weights.

The custom-built parallel gearbox of the prior art is also undesirably time consuming and expensive to repair. More particularly, when the gearbox is repaired in the field, multiple trips by mechanics typically are required. For example, the mechanics must make a first trip to secure and/or remove components of the pumping unit as described above, which enables them to disassemble the gearbox, diagnose the problem, and secure a list of parts that need to be replaced. The parts for the repair of the custom gearbox typically can only be purchased from the original manufacturer, and may have to be specially made, which results in significant down time for the pumping unit. Once the replacement parts are obtained, the mechanics must make another trip to the pumping unit to repair the gearbox and reassemble the pumping unit. This process is undesirably long and expensive, and during the long down time of the pumping unit no oil and/or gas is produced by the well, resulting in additional lost revenue for the well owner. As a result, there is a need in the art for a pumping unit that includes an inexpensive gear reducer which is readily commercially available to the end user, and which may be replaced quickly and economically.

The custom-built parallel gearbox of the prior art also typically has a reduction ratio of 30:1, and when this ratio is combined with the reduction of the belt and sheaves, it often yields an operating speed of the pumping unit between 9 to 10 strokes per minute (spm). Such a high stroke speed may be advantageous to pump a large amount of fluid, but may undesirably increase the amount of stress on the string of rods in the well and the amount of stress on the pumping unit itself. In addition, if the foundation under the base of the pumping unit becomes out-of-level, a high stroke speed of about 10 spm may cause the pumping unit to rock back and forth, which may damage the pumping unit.

Moreover, a stroke speed of 10 spm requires more horsepower (hp) and torque than a lower stroke speed, which is undesirable for both electric motors and internal combustion engines. More particularly, many pumping units are far away from a main electric line, and the amperage available to an electric motor decreases as the distance between the motor and the main electric line increases. Thus, in some cases, the distance between the main electric line and the motor is large enough that there is not enough amperage available to enable the motor to generate adequate horsepower to run such a high-stroke-speed pumping unit.

For an internal combustion engine, the engine must run at high rpm to develop the necessary horsepower that is required to operate the pumping unit. When the stroke speed of the pumping unit is high, more horsepower is required of the internal combustion engine, and the engine must therefore operate at a higher rpm. At a higher rpm, the internal combustion engine may experience operating problems, which may undesirably cause the engine to stall. Therefore, there is a need in the art for a pumping unit that includes a gear reducer having a deeper gear reduction ratio, such as about 50:1, which, in combination with the sheaves on the motor, may result in a stroke speed as low as about 4 spm, while being capable of stroke speeds up to about 10 spm by changing sheave sizes.

The parallel-gearbox type of gear reducers of the prior art also undesirably have limited torque ratings or torque capability. When conditions change down in the well, the pumping unit may have to provide increased force to continue to actuate the reciprocating piston pump that is in the well. Such increased force requirements in turn increase the amount of torque that is placed on the gear reducer. This increased torque sometimes exceeds the maximum torque ratings of the prior art parallel gearboxes, which may undesirably damage the gearbox. As a result, there is a need in the art for a pumping unit that includes a gear reducer having a high peak torque rating to accommodate changing well conditions.

Another disadvantage of prior art pumping units is the use of different styles of bearing components, such as pins, bushings, and bearings throughout the pumping unit. Many of these pins, bushing and bearings are custom made by the manufacturer, which forces the end user to purchase these components from the manufacturer at a premium price. Thus, it becomes expensive for an end user to keep an inventory of such components, and without such an inventory, the end user may often have wait for up to six weeks for needed components to be made and shipped. In addition, if the manufacturer goes out of business, it may not be possible to obtain the needed components, which may undesirably result in the pumping unit being scrapped. Therefore, there is a need in the art for a pumping unit that includes commercially available bearing components for convenient and cost effective replacement.

Still another disadvantage of prior art pumping units is the difficulty of adjusting the beam weights to properly counterbalance the load that is on the horse head. Achieving such a proper balance of the beam is critical, as proper balance minimizes the stress on the pumping unit and minimizes the amount of horsepower that is required to run the unit. Thus, a well-balanced pumping unit will sustain a much longer operating life and will also consume much less power than an improperly-balanced unit. To achieve proper balance of the beam, a mechanic or operator may have to add or remove individual weights on the rearward end of the beam. Due to the significant size and mass of each individual weight, it may be difficult for the operator to add or remove the weights without a lifting device, which increases the time and expense associated with balancing the beam, and undesirably reduces the ability of the operator to accurately balance the beam. As a result, there is a need in the art for a pumping unit that includes an improved system for proper balancing of the walking beam weights, including easy adjustment of the position of the weights and securing of the weights in a balanced position.

Yet another disadvantage of prior art pumping units is the lack of automatic belt tensioning of the motor. More particularly, when the pumping unit is driven by an electric motor, the output shaft of the motor is connected to the input shaft of the gear reducer by belts and sheaves. If the belts are not tight, they will slip and may eventually burn up. While manual adjustment of the belt tension or replacement of the belts alleviates the problem, such adjustment or replacement is time consuming and costly, and therefore is not frequently performed. Therefore, there is a need in the art for a pumping unit that includes an automatic belt tensioner, which maintains proper drive belt tension.

In addition, when belts are used with an electric motor, prior art pumping units lack the ability to enable an operator to declutch the pumping unit or disengage the motor to selectively cause the belts to slip. Declutching the pumping unit to cause the belts to slip is desirable when it is necessary to slow the walking beam oscillation in order to stop the beam at a specific position, such as stopping the horse head at a height that enables adjustment of the attachment of the string of rods to the wireline. In the prior art, to stop the beam at a specific position, the inability to declutch the pumping unit or disengage the motor to cause the belts to slip has required the operator to turn the electricity on and off while trying to catch the walking beam in the desired position using a walking beam brake mechanism, which may be inconvenient and/or inaccurate. As a result, there is a need in the art for a pumping unit that includes a system that enables easy disengagement of the motor and simultaneous application of the walking beam brake to conveniently stop the walking beam at a desired position.

Another disadvantage of prior art pumping units is the amount of moving components associated with the above-described four-bar lever system. More particularly, the four-bar lever system involves a pair of crank arms, each one of which is mounted on a respective side of the gear reducer, and a pair of Pitman arms, each one of which is connected to a respective crank arm. When the crank arms rotate, each crank arm passes inside of its respective Pitman arm in a scissor action on each side of the pumping unit. As a result of this action, the pumping unit typically is fenced in where there is a populated area to prevent accidental contact with the crank system. However, even when the pumping unit is fenced in, an operator may sometimes have to go inside the fence to shut the pumping unit down to perform maintenance on the unit, which may be undesirable. Therefore, there is a need in the art for a pumping unit having a design that enables an integrated enclosure to be included around the crank system.

As a result of the above-described disadvantages of prior art pumping units, there is a need in the art for a pumping unit that overcomes one or more of such disadvantages. The present invention satisfies this need, as will be described below.

### BRIEF SUMMARY OF THE INVENTION

An objective of the present invention is to provide a pumping unit that includes a crank system which supports the heavy loads of the walking beam and the beam weights and converts the rotational motion of the crank into reciprocating motion at the horse head, while being independent of the gear reducer.

Another objective of the present invention is to provide a pumping unit in which the gear reducer is only used for rotating the crank system, so that the reducer is not subject to the heavy loads of the walking beam and beam weights.

Yet another objective of the present invention is to provide a pumping unit in which the crank assembly is capable of being positively locked in position to secure the walking beam, beam weights, Pitman arms, crank arms, and rod string without any disassembly of these components when it is necessary to service the gear reducer.

Still another objective of the present invention is to provide a pumping unit in which the gear reducer is not mounted under the walking beam and beam weights, and which can be quickly replaced.

A further objective of the present invention is to provide a pumping unit that includes an inexpensive gear reducer, which is commercially available to the end user, and may be quickly and economically replaced.

Yet another objective of the present invention is to provide a pumping unit that includes a gear reducer with a deeper gear reduction ratio, which yields a stroke speed as low as about four (4) spm, and is capable of attaining higher stroke speeds.

Still another objective of the present invention is to provide a pumping unit that includes a uniform and commercially available bearing system throughout the crank system and under the walking beam.

A further objective of the present invention is to provide a pumping unit that includes an improved system for proper balancing of the walking beam weights, including easy adjustment of the position of the weights and securing of the weights in a balanced position.

Yet another objective of the present invention is to provide a pumping unit that includes an automatic belt tensioning system.

Still another objective of the present invention is to provide a pumping unit that includes a system to disengage the belts of a belt drive while enabling an operator to simultaneously apply a walking beam brake.

A further objective of the present invention is to provide a pumping unit that includes a design that minimizes the exposure of moving parts, and which includes an integrated enclosure around the crank assembly.

These objectives and others are obtained by the pumping unit of the present invention. In an exemplary embodiment of the invention, a pumping unit for removing fluid from a well includes a base that is disposed adjacent the well. A plurality of support posts are mounted on the base, and the support posts extend upwardly and are connected to a center bearing. A walking beam is pivotally mounted on the center bearing. A single Pitman arm is pivotally connected to the walking beam rearwardly of the center bearing, and extends downwardly from the walking beam. A crank assembly is mounted on the base generally centrally beneath and is operatively connected to the Pitman arm. A gear reducer is mounted on and is operatively connected to the crank assembly. A drive unit is mounted on the base and is operatively connected to the gear reducer. Actuation of the drive unit actuates motion of the gear reducer, the crank assembly and the Pitman arm, which actuates pivotal movement of the walking beam to pump the fluid from the well.

In another exemplary embodiment of the invention, a pumping unit for removing fluid from a well includes a base that is disposed adjacent the well. A plurality of support posts are mounted on the base, and the support posts extend upwardly and are connected to a center bearing. A walking beam is pivotally mounted on the center bearing, and an adjustable weight system is mounted on a rearward end of the walking beam. A Pitman arm is pivotally connected to the walking beam rearwardly of the center bearing, and extends downwardly from the walking beam. A crank assembly is mounted on the base and is operatively connected to the Pitman arm. A gear reducer is mounted on and is operatively connected to the crank assembly. A drive unit is mounted on the base and is operatively connected to the gear reducer. Actuation of the drive unit actuates motion of the gear reducer, the crank assembly and the Pitman arm, which actuates pivotal movement of the walking beam to pump the fluid from the well.

In yet another exemplary embodiment of the invention, a pumping unit for removing fluid from a well includes a base that is disposed adjacent the well. A plurality of support posts are mounted on the base, and the support posts extend upwardly and are connected to a center bearing. A walking beam is pivotally mounted on the center bearing. A Pitman arm is pivotally connected to the walking beam rearwardly of the center bearing, and extends downwardly from the walking beam. A crank assembly is mounted on the base and is operatively connected to the Pitman arm. A gear reducer is mounted on and is operatively connected to the crank assembly. A drive unit is operatively connected to the gear reducer and is mounted on a hinged platform. The hinged platform is mounted on the base and includes a hinge point forward of the weight of the drive unit. Actuation of the drive unit actuates motion of the gear reducer, the crank assembly and the Pitman arm, which actuates pivotal movement of the walking beam to pump the fluid from the well.

### BRIEF DESCRIPTION OF THE SEVERAL VIEWS OF THE DRAWINGS

The preferred embodiments of the present invention, illustrative of the best mode in which applicants have contemplated applying the principles, are set forth in the following description and are shown in the drawings, and are particularly and distinctly pointed out and set forth in the appended claims.

FIG. 1 is an elevational side view of a pumping unit of the prior art;

FIG. 2 is an elevational end view of the pumping unit shown in FIG. 1;

FIG. 3 is a perspective view of a pumping unit of the prior art shown installed at a well;

FIG. 4 is an enlarged perspective view of a parallel gearbox used in the prior art pumping units shown in FIGS. 1-3, with the top cover of the gearbox removed;

FIG. 5 is a side elevational view of a first exemplary embodiment of the pumping unit of the present invention;

FIG. 6 is an end elevational view of a portion of the pumping unit shown in FIG. 5;

FIG. 7 is a side elevational view of the gear reducer and crank assembly of the pumping unit shown in FIG. 5;

FIG. 8 is a plan view of the gear reducer and crank assembly shown in FIG. 7, with the gear reducer removed from the crank assembly;

FIG. 9 is a plan view of the gear reducer and crank assembly of the pumping unit shown in FIGS. 7 and 8 with the gear reducer installed on the crank assembly;

FIG. 10 is an enlarged exploded perspective view of certain components of a planetary gear reducer used in the pumping unit shown in FIG. 5;

FIG. 11A is an enlarged side elevational view of a pillow block bearing used in the pumping unit shown in FIG. 5;

FIG. 11B is an end elevational view of the pillow block bearing shown in FIG. 11A;

FIG. 12 is a fragmentary side elevational view of the crank assembly of the pumping unit shown in FIG. 5, with the crank assembly locked for servicing;

FIG. 13 is a plan view of the crank assembly shown in FIG. 12, with a planetary gear reducer installed on the crank assembly;

FIG. 14A is a fragmentary enlarged side elevational view of the rearward end of the walking beam of the pumping unit shown in FIG. 5;

FIG. 14B is a greatly enlarged view of the circled portion of the walking beam shown in

FIG. 14A;

FIG. 15A is an enlarged fragmentary side elevational view of the motor and associated components at the rearward end of the pumping unit shown in FIG. 5, with a belt tensioning system and belt disengagement system, and showing the motor in a running position;

FIG. 15B is a fragmentary side elevational view of the motor and associated components shown in FIG. 15A, with the motor in a belt-changing position;

FIG. 15C is a fragmentary end elevational view of certain components shown in FIG. 15A, with exemplary positions of a tensioning lever of the belt disengagement system;

FIG. 16 is a side elevational view of the pumping unit shown in FIG. 5, with an integrated enclosure;

FIG. 17 is a plan view of a gear reducer and crank assembly of a second exemplary embodiment of the pumping unit of the present invention;

FIG. 18 is a plan view of a gear reducer and crank assembly of a third exemplary embodiment of the pumping unit of the present invention;

FIG. 19A is a fragmentary enlarged side elevational view, with certain components represented by dashed lines, of the rearward end of the walking beam of the pumping unit shown in FIG. 6, with an alternative embodiment weight pack system; and

FIG. 19B is an end elevational view of the walking beam and weight pack system shown in FIG. 19A.

Similar numerals refer to similar parts throughout the drawings.

### DETAILED DESCRIPTION OF THE INVENTION

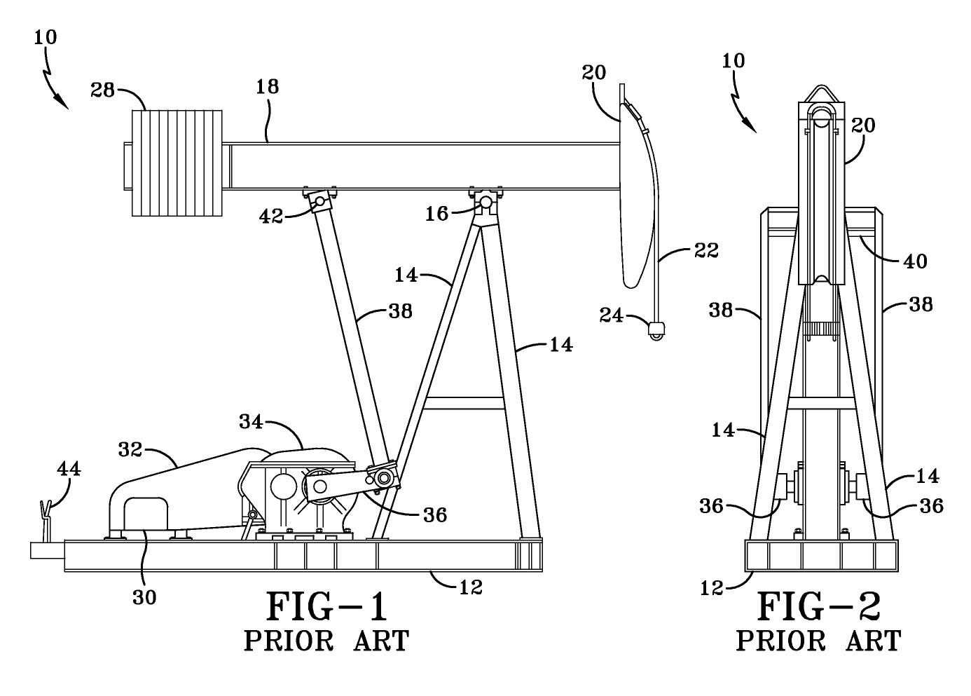

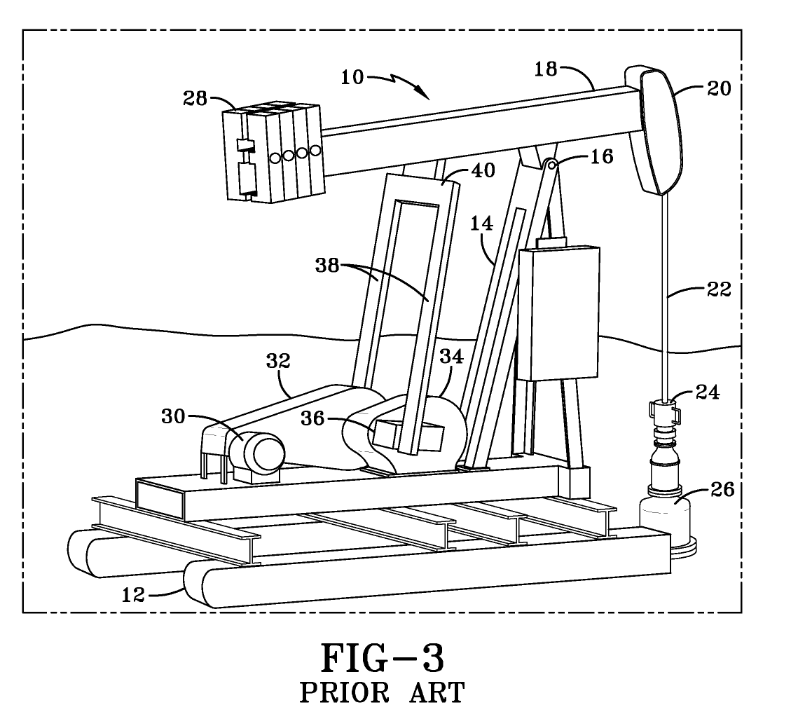

So that the structure, operation and advantages of the pumping unit of the present invention can best be understood, a typical prior art pumping unit is shown in FIGS. 1-4, and now will be described. With particular attention to FIGS. 1-3, the prior art pumping unit is indicated generally at 10, and includes a base 12 that is placed on a foundation adjacent the bore hole of a well (not shown). A plurality of integrated support posts 14, each of which is known in the art as a Samson post, is mounted on base 12 and extends upwardly to a center bearing 16. A walking beam 18 is mounted on center bearing 16 so that the center bearing is the pivot point for oscillation of the beam. A horse head 20 is attached to a forward end of walking beam 18, and a wireline 22 is attached to and extends between the horse head and a carrier bar 24. Carrier bar 24 in turn is attached to a rod string 26 (FIG. 3), which extends into the well. As described above, wireline 22 follows the curve of horse head 20 as the forward end of walking beam 18 raises and lowers, which enables pumping unit 10 to provide a vertical stroke of rod string 26.

Weights 28 are mounted on a rearward end of walking beam 18 to act as a counterbalance to the weight of rod string 26. As described above, a drive unit 30 drives the oscillation of walking beam 18 about center bearing 16. Drive unit 30 typically is an electric motor or an internal combustion engine, and is shown herein as an electric motor for the purpose of convenience. Motor 30 is connected by belts and sheaves (under cover 32) to a gear reducer 34, which will be described in greater detail below. Gear reducer 34 is located between and is pivotally connected to a pair of crank arms 36, and each one of the crank arms is in turn pivotally connected to a respective one of a pair of Pitman arms 38. Each Pitman arm 38, in turn, is connected to an equalizer bar 40 that extends between the Pitman arms. Equalizer bar 40 is connected to a tail bearing 42, which is connected to walking beam 18 rearwardly of center bearing 16.

This connection of motor 30 to gear reducer 34, to crank arms 36, to Pitman arms 38 and to walking beam 18 enables the walking beam to be driven in an oscillating manner about center bearing 16. The use of two crank arms 36 and two Pitman arms 38 is known as a four-bar lever system, which converts rotational motion from motor 30 to reciprocating motion at horse head 20. When motor 30 is turned off and it is desired to stop the motion of walking beam 18, a brake lever 44 is actuated by an operator, as known in the art.

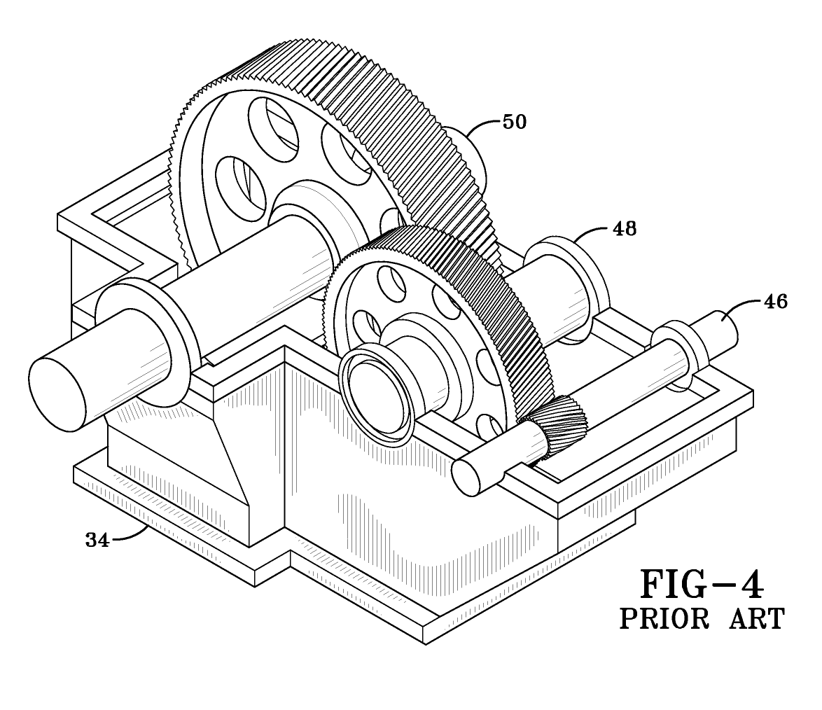

As shown in FIG. 4, prior art gear reducer 34 is a parallel gearbox. Parallel gearbox 34 includes a high speed gear shaft 46, which is connected to motor 30 (FIG. 3) via sheaves and belts. High speed gear shaft 46 contacts a medium speed gear shaft 48, which in turn contacts a low speed gear shaft 50. Each end of low speed gear shaft 50 is connected to a respective one of crank arms 36 (FIG. 3). This construction enables parallel gearbox 34 to reduce the number of rpm generated by motor 30, and to provide the torque capacity to enable walking beam 18 to oscillate. Parallel gearbox 34 includes two total gear contact points, that is, one contact point between high speed gear shaft 46 and medium speed gear shaft 48, and another contact point between the medium speed gear shaft and low speed gear shaft 50. In the prior art, the torque capacity of high speed gear shaft 46, which is the smallest gear shaft, typically limits the torque rating of parallel gearbox 34.

As described above, prior art pumping unit 10 includes certain disadvantages that are associated with the design of crank arms 36, the location and design of parallel gearbox 34, the use of non-standard bearings, difficulty in adjusting weights 28, the lack of belt tensioning for motor 30, the lack of an ability to declutch the belts to easily stop walking beam 18 at a selected position, and the difficulty associated with enclosing the pumping unit. The pumping unit of the present invention overcomes the disadvantages of prior art pumping units, as now will be described.

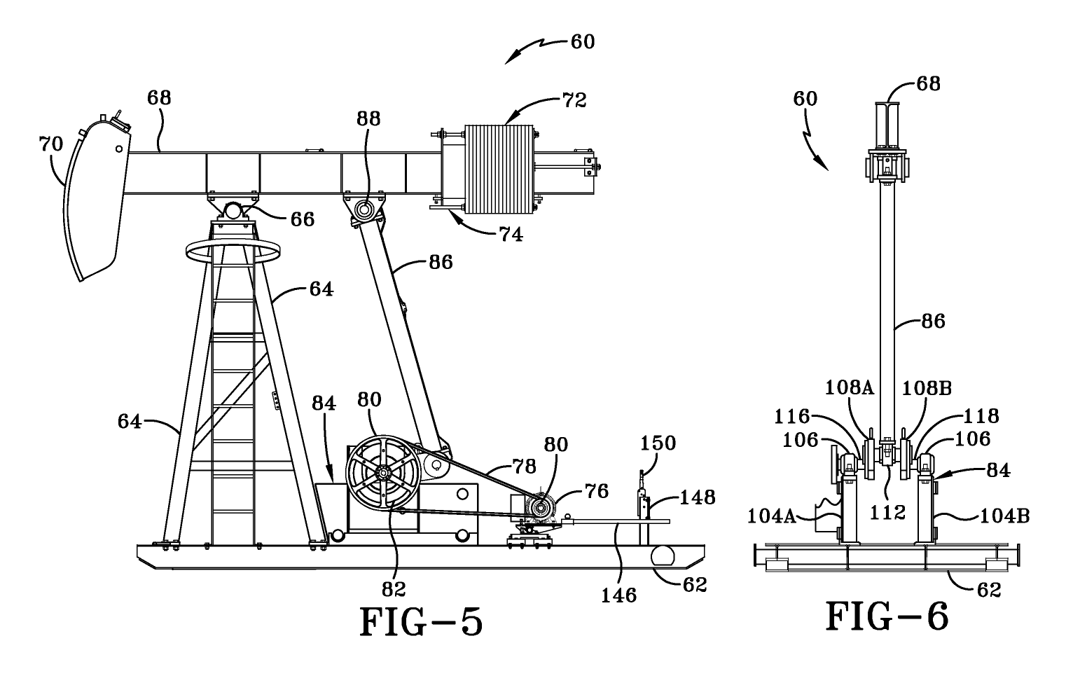

A first exemplary embodiment of a pumping unit of the present invention is indicated generally at 60 and is shown in FIGS. 5-16. With particular attention to FIGS. 5 and 6, pumping unit 60 includes a base 62 that is placed on a foundation adjacent the bore hole of a well (not shown). A plurality of integrated support posts 64, each one of which is known in the art as a Samson post, is mounted on base 62 and extends upwardly to a center bearing 66. A walking beam 68 is mounted on center bearing 66 so that the center bearing is the pivot point for oscillation of the beam. A horse head 70 is attached to a forward end of walking beam 68, and a wireline (not shown) is attached to and extends between the horse head and a carrier bar (not shown). The carrier bar in turn is attached to a rod string (not shown), which extends into the well.

A weight pack 72 and trolley 74 are mounted on a rearward end of walking beam 68 to act as a counterbalance to the weight of the rod string, and will be described in greater detail below. A drive unit 76 drives the oscillation of walking beam 68 about center bearing 66. Drive unit 76 may be an electric motor or an internal combustion engine, and is shown herein as an electric motor for the purpose of convenience. Motor 76 is connected by belts 78 and sheaves 80 to a gear reducer 82, which will be described in greater detail below. Gear reducer 82 is located to the side of and is pivotally connected to a crank assembly 84, which will also be described in greater detail below. Crank assembly 84 is pivotally connected to one Pitman arm 86. Pitman arm 86 is directly connected to a tail bearing 88, which in turn is connected to walking beam 68 rearwardly of center bearing 66.

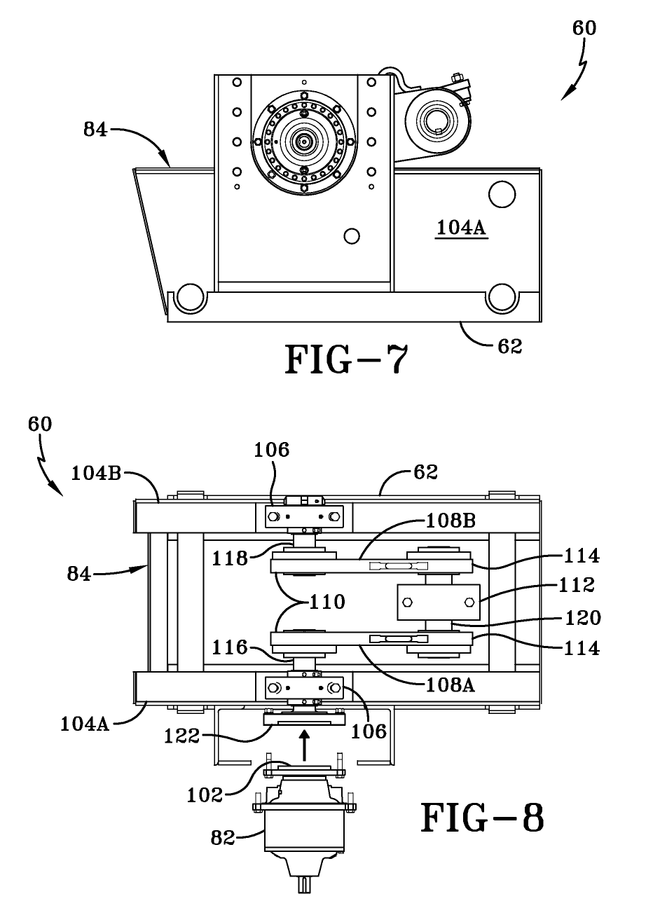

As shown in FIG. 6, and with additional reference to FIGS. 7-9, crank assembly 84 is a heavy-duty crank system that is mounted centrally under a single Pitman arm 86. By providing only crank assembly 84 under Pitman arm 86, the crank assembly supports the heavy loads of walking beam 68 and beam weight pack 72, which converts the rotational motion at the crank assembly into reciprocating motion at horse head 70, thereby enabling the crank assembly to be independent of gear reducer 82. Because crank assembly 84 and gear reducer 82 are independent from one another, the gear reducer does not have to support the heavy load of walking beam 68 and weight pack 72. As a result, gear reducer 82 does not need to be a custom-built parallel gearbox, and instead preferably is a planetary gear reducer.

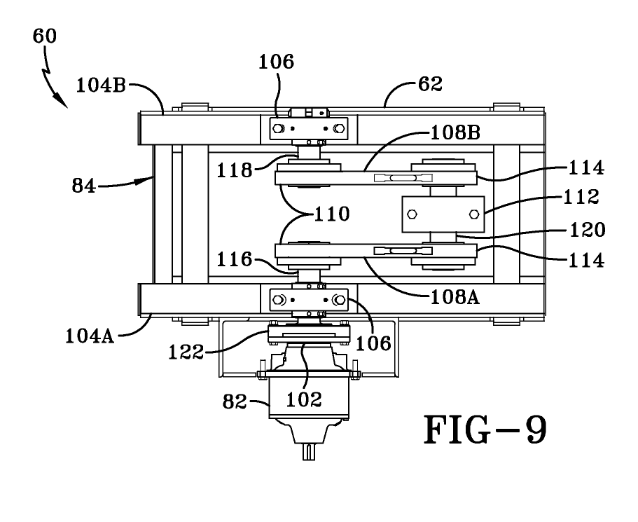

Turning now to FIG. 10, an exemplary construction for planetary gear reducer 82 is shown. More particularly, a primary sun gear 90 rotates in the direction of the output shaft of motor 76 (FIG. 5), for example, counterclockwise. Primary sun gear 90 contacts three primary planet gears 92 and causes them to rotate in an opposite direction (e.g., clockwise). These three primary planet gears 92 are mounted in a primary carrier 94, which is driven in the same direction as the output shaft of motor 76 (e.g., counterclockwise) by the contact between primary sun gear 90 and the three primary planet gears. A secondary sun gear 96 is attached to primary carrier 94 and is driven in the same direction as the primary carrier (e.g., counterclockwise). Secondary sun gear 96 contacts three secondary planet gears 98 and causes them to rotate in a direction opposite the secondary sun gear (e.g., clockwise). These three secondary planet gears 98 are mounted in a secondary carrier 100, which is driven in the same direction as secondary sun gear 96 (e.g., counterclockwise). An output shaft 102 assembly is connected to secondary carrier 100 and rotates in the same direction as the secondary carrier (e.g., counterclockwise).

This construction of planetary gear reducer 82 creates a double reduction with a total of six contact points, that is, three contact points between primary sun gear 90 and each one of the primary planet gears 92, and three contact points between secondary sun gear 96 and each one of the secondary planet gears 98. Six contact points in turn provides a greater maximum torque rating and a deeper reduction ratio than is possible with parallel gearbox 34 of the prior art. The deeper reduction ration of planetary gear reducer 82 may yield a stroke rate that is as low as 4 spm, which requires much less horsepower to generate. In addition, by changing sheaves 80 on motor 76 and gear reducer 82 (FIG. 5), a higher stroke rate, such as about 10 spm, may be attained.

Returning now to FIGS. 7-9, since planetary gear reducer 82 is mounted to one side of crank assembly 84, rather than under walking beam 68 and weight pack 72 (FIG. 5), the gear reducer is only used for rotating the crank assembly and thus is not subject to the heavy loads of the walking beam and weight pack. This design of pumping unit 60 enables planetary gear reducer 82 to be an inexpensive gear reducer that is commercially available. Such commercial availability enables gear reducer 82 to be replaced economically and quickly, thereby desirably reducing any down time for pumping unit 60 for repairs. In addition, the positioning of planetary gear reducer 82 to the side of Pitman arm 86 and the stroke of walking beam 68 enables the gear reducer to be replaced with the mechanic being in a safe position.

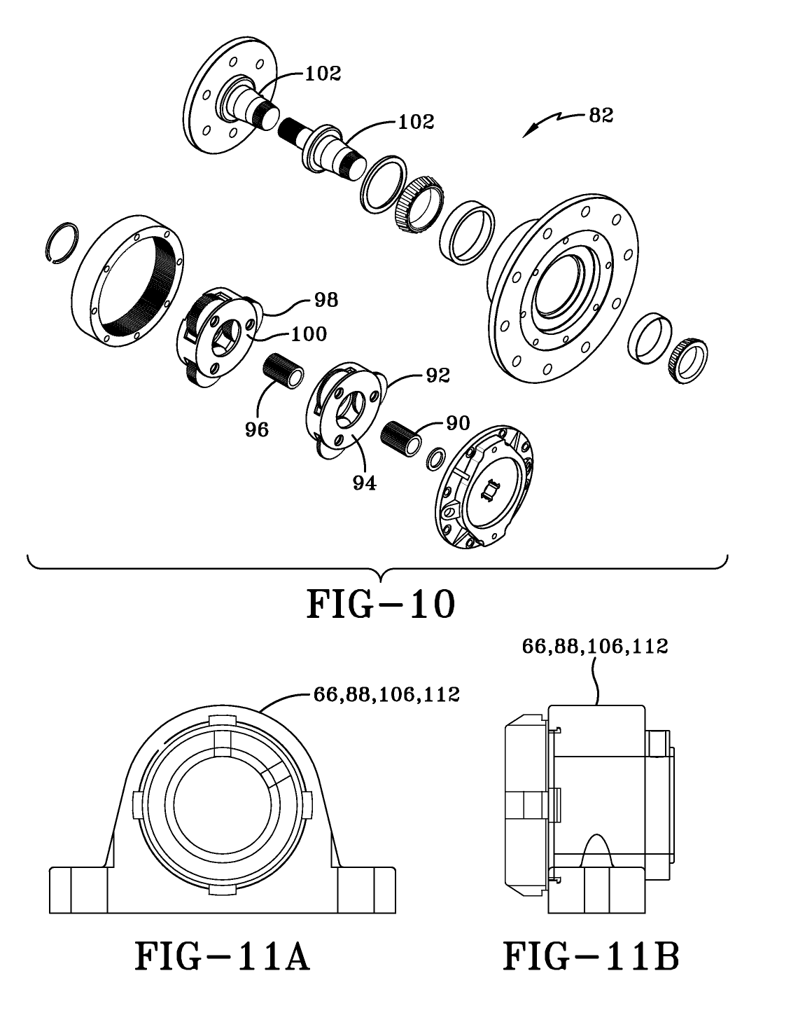

With continuing reference to FIGS. 7-9, output shaft 102 of planetary gear reducer 82 is connected to crank assembly 84, which is of a heavy-duty construction. More particularly, crank assembly 84 includes a pair of walls 104A, 104B that are mounted on pumping unit base 62 (FIG. 5) and extend parallel to one another in a longitudinal manner relative to the pumping unit base. With additional reference to FIGS. 11A and 11B, a pillow block bearing 106 is mounted on each wall 104A, 104B and each bearing preferably includes sealed, self-aligned spherical rollers. A pair of crank arms 108A, 108B is disposed inwardly of and extends generally parallel to walls 104A, 104B. A first end 110 of each crank arm 108A, 108B is pivotally mounted to and is supported by a respective one of each of the pillow block bearings 106 via respective shafts 116, 118. Each crank arm 108A, 108B includes a second end 114, and both crank arm second ends are connected to one another at their respective second ends by a shaft 120 that extends between them. A central pillow block bearing 112 is pivotally mounted on shaft 120, and single Pitman arm 86 (FIG. 6) is rigidly attached to the central pillow block bearing.

As shown in FIGS. 7-9, in order to drive crank assembly 84, output shaft 102 of planetary gear reducer 82 is connected to a mounting flange 122, which in turn is connected to shaft 116.

Shaft 116 extends through pillow block bearing 106 on wall 104A, that is, the wall that is located on the same side of pumping unit 60 as gear reducer 84, and extends to crank arm 108A. The connection of motor 76 to planetary gear reducer 82, to crank arms 108A, 108B, to single Pitman arm 86 and to walking beam 68 enables the walking beam to be driven in an oscillating manner about center bearing 66, thereby converting rotational motion from the motor to reciprocating motion at horse head 70 in a manner that is different from the four-bar system of the prior art. Preferably, pillow block bearings 106 and 112, as well as center bearing 66 and tail bearing 88, are all commercially available pillow block bearings of the same style or type, which reduces costs and enables convenient and easy replacement.

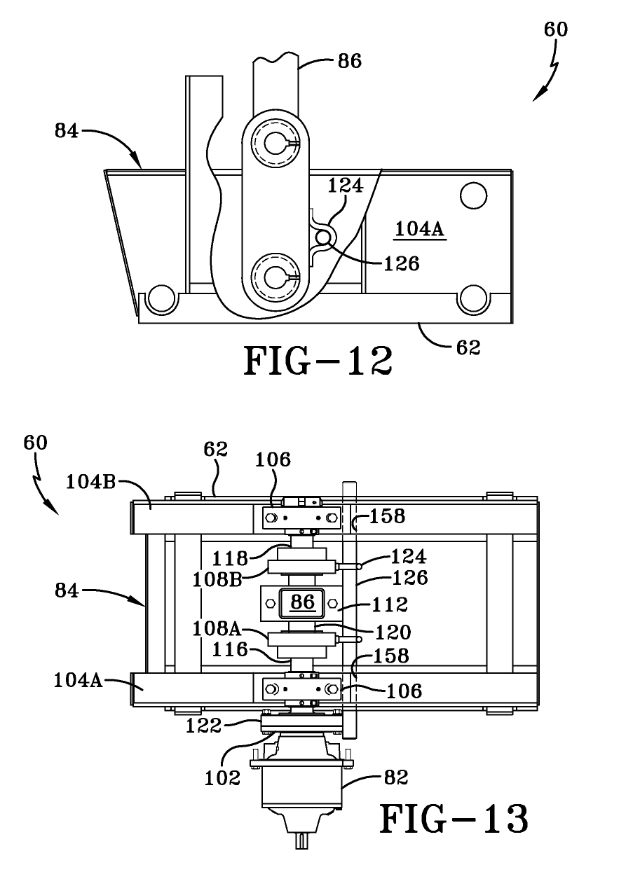

Turning now to FIGS. 12 and 13, crank assembly 84 may be positively locked in position to safely secure walking beam 68 (FIG. 5), beam weight pack 72, single Pitman arm 86, crank arms 108A, 108B, and the rod string without any disassembly of these parts when it becomes necessary to service planetary gear reducer 82. More particularly, each crank arm 108A, 108B includes a locking eye 124, and walls 104A, 104B are formed with openings 158. Locking eyes 124 remain aligned with one another and may selectively be aligned with openings 158, so that when pumping unit 60 is stopped, a lock down bar 126 may easily be inserted through the wall openings and through the locking eyes. When lock down bar 126 is inserted through locking eyes 124 and the aligned wall openings 158, crank assembly 84 cannot rotate, which in turn locks single Pitman arm 86 and walking beam 68 in position. In this manner, the design of crank assembly 84 provides easy and safe positive locking of walking beam 68 without chaining horse head 70 to base 62, as was done in the prior art.

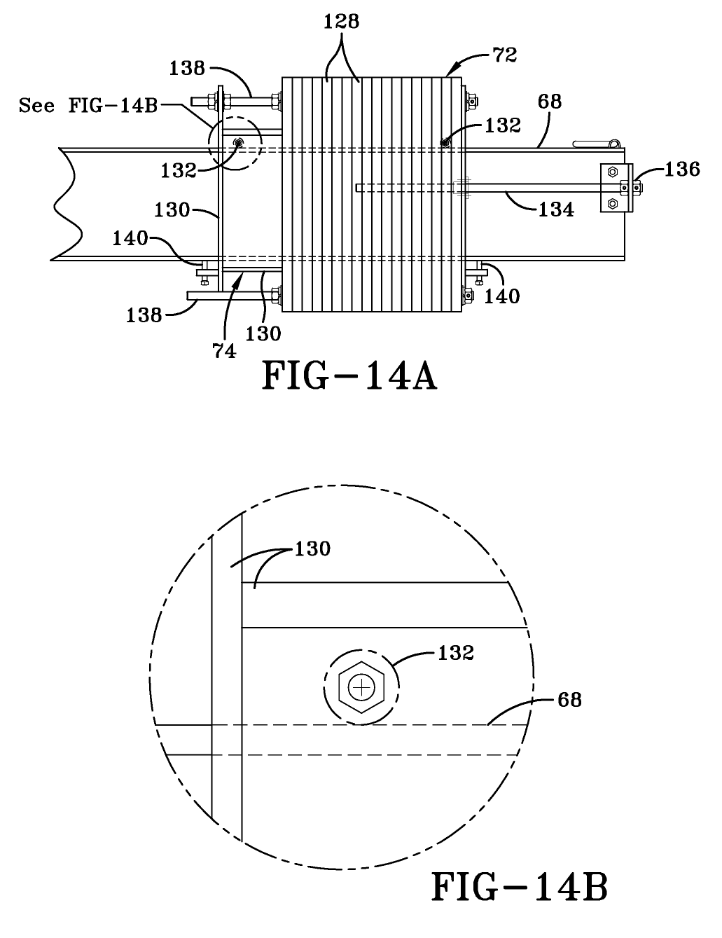

With reference now to FIGS. 14A and 14B, pumping unit 60 also includes a structure that enables quick and easy adjustment of the counterbalance weights. More particularly, weight pack 72 is mounted on trolley 74, and the relative position of the trolley along the rearward end of walking beam 68 is easily adjustable. Individual weights 128, which make up weight pack 72, are placed on a trolley frame 130 and are secured to the frame by bolts 138. Trolley frame 130 slides over walking beam 68 from the rearward end of the beam. Disposed between trolley frame 130 and walking beam 68 are roller bearings 132, which enable trolley 74 with weight pack 72 to easily roll along the walking beam.

Movement of trolley 74 and thus weight pack 72 is controlled by an adjusting screw 134, which is rigidly affixed to the rearward end of walking beam 68 and threadably engages trolley frame 130. Adjusting screw 134 preferably is a jack screw, so that rotation of screw head 136 causes trolley frame 130, and thus trolley 74 and weight pack 72, to selectively move forwardly or rearwardly along walking beam 68. Once weight pack 72 is in a position that properly balances pumping unit 60, trolley assembly 74 is locked in place along walking beam 68 by tightening lock down screws 140. Preferably, four lock down screws 140 are disposed on the bottom of trolley frame 130, that is, two on each side of the trolley frame, and engage the bottom wall of walking beam 68. In this manner, trolley 74 provides easy and safe adjustment of weight pack 72 on beam 68.

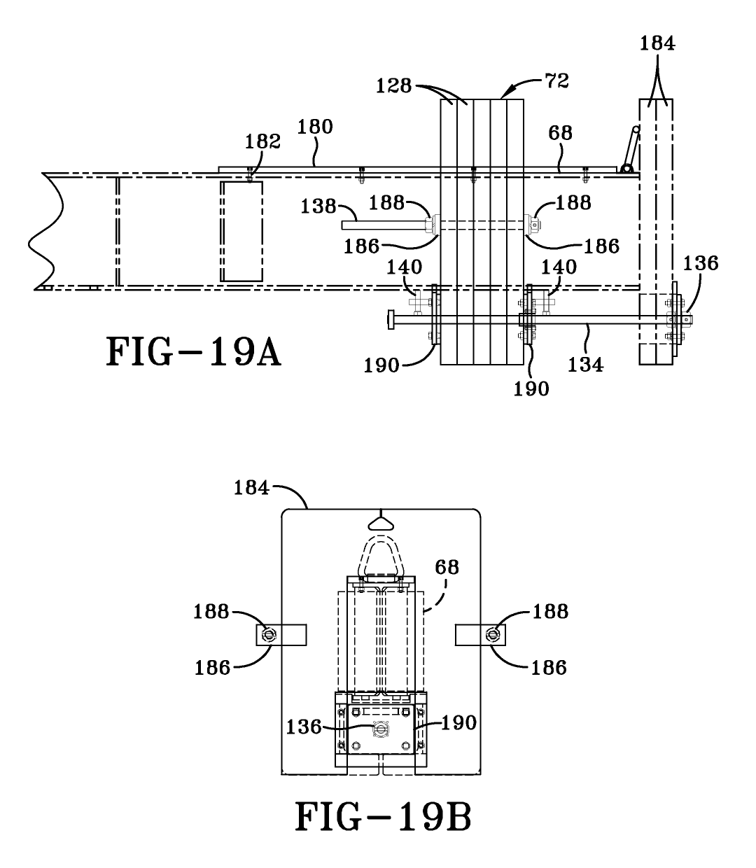

An alternative embodiment of a structure for quick and easy adjustment of the counterbalance weights is shown in FIGS. 19A-19B. More particularly, a strip 180 of low friction material is secured to the top surface of the rearward end of walking beam 68 by mechanical fasteners 182, or by an adhesive. Strip 180 preferably is formed of a polymer, and more preferably is formed of a polymer such as ultra-high molecular weight polyethylene or polytetrafluoroethylene. Weights 128 of weight pack 72 are mounted directly on low-friction strip 180, and bolts 138, in cooperation with retainer plates 186 and nuts 188, secure the weights together. This mounting of weight pack 72 on low-friction strip 180 enables the weight pack to easily slide along walking beam 68 to adjust the relative position of the weight pack along the rearward end of the walking beam.

In addition, one or more permanently affixed weights 184 preferably are mounted on the rear surface of walking beam 68 by welding or other means known in the art. Permanently affixed weights 184 reduce the number of weights 128 that are included in weight pack 72. The location of weight pack 72 is controlled by adjusting screw 134, which is rigidly affixed to permanently affixed weights 184 and threadably engages end plates 190 of weight pack 72. Rotation of screw head 136 causes weight pack 72 to selectively move forwardly or rearwardly along walking beam 68. Once weight pack 72 is in a position that properly balances pumping unit 60, weight pack 72 is locked in place along walking beam 68 by tightening lock down screws 140. In this manner, low friction strip 180 provides an alternative to the use of trolley 74 (FIG. 14A) for the easy and safe adjustment of weight pack 72 on beam 68.

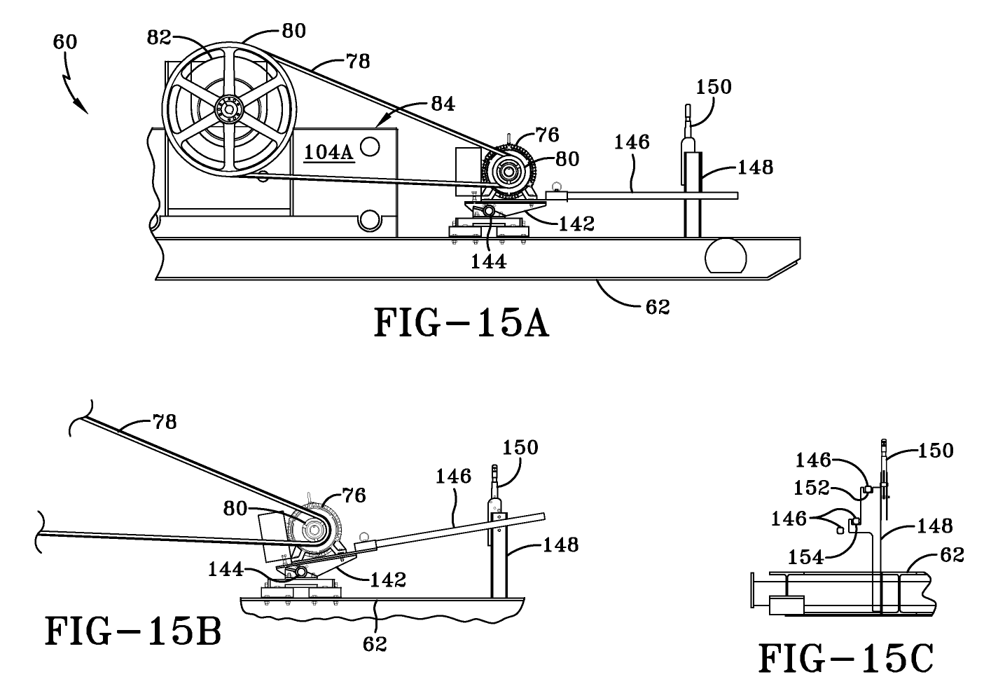

Turning now to FIGS. 15A-15C, pumping unit 60 of the present invention includes an automatic belt tensioning system which can also be used to change belts quickly and easily. More particularly, motor 76 is mounted on a hinged platform 142, which in turn is mounted on pumping unit base 62. Hinge point 144 of motor platform 142 is forward of the weight of motor 76, and thereby keeps the weight of the motor rearward of the hinge point. Sheave 80 and the connection of belts 78 to motor 76 is also rearward of hinge point 144, so that the motor pulls hinged platform 142 downwardly at the rearward end of the belts. This downward force enables the weight of motor 76 to keep belts 78 in tension automatically, which reduces the tendency of the belt to slip. In addition, during operation of motor 76, the belt loads typically increase, and the rearward end of motor platform 142 is forced downwardly by the reaction torque of the motor, which continues to maintain the tension of belts 78.

Pumping unit 60 also includes a structure that enables an operator to totally or partially disengage belts 78, and thus control the motion of the pumping unit to stop horse head 70 (FIG. 5) at a predetermined position, or to easily change the belts. More particularly, a tensioning lever 146 is mounted on the rearward end of motor platform 142. Optionally, tensioning lever 146 may be removable. Tensioning lever 146, when connected to motor platform 142, extends rearwardly to a slotted post 148, which is mounted on pumping unit base 62. Preferably, an upper slot 152 and a lower slot 154 are formed in post 148, and each slot accepts the rearward end of lever 146, as will be described in greater detail below. A brake lever 150 is mounted on slotted post 148, and is actuated by an operator when it is desired to stop the motion of walking beam 68, as will also be described below.

When it is desired to stop the movement of horse head 70, an operator lifts tensioning lever 146 and inserts it into lower slot 154. The lifting of tensioning lever 146 to lower slot 154 raises the rearward end of hinged motor platform 142, which moves sheave 80 toward planetary gear reducer 82, thereby loosening belts 78. Because lower slot 154 is only slightly higher than the normal run position for tensioning lever 146, sheave 80 moves just enough to cause belts 78 to slip, which effectively declutches them. In this manner, the driven movement of walking beam 68 and horse head 70 are slowed, and because brake lever 150 is beside lower slot 154 and tensioning lever 146, the operator can easily and safely engage the brake to stop the horse head when it reaches a desired position. Once pumping unit 60 is to be restarted, the operator moves tensioning lever 146 out of lower slot 154 to its normal position, which enables the rearward end of motor platform 142 to move downwardly and re-tighten belts 78 on sheave 80.

When it is desired to change belts 78, an operator turns motor 76 off, lifts tensioning lever 146 and inserts it into upper slot 152. The lifting of tensioning lever 146 to upper slot 152 significantly raises the rearward end of hinged motor platform 142, which moves sheave 80 toward planetary gear reducer 82 and reduces the distance between them enough to loosen belts 78 so that they can be removed. Preferably, the operator engages brake lever 150 to stop the motion of walking beam 68, and is then able to easily replace belts 78. Once belts 78 are replaced, the operator moves tensioning lever 146 out of upper slot 152 to its normal position, which enables the rearward end of motor platform 142 to move downwardly and re-tighten the belts on sheave 80.

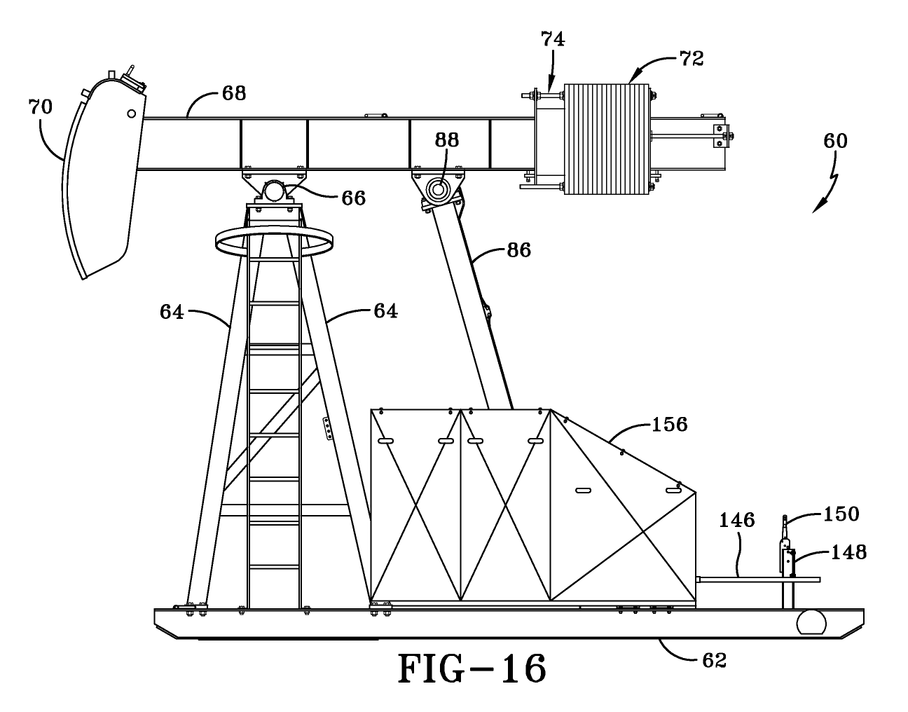

With reference now to FIG. 16, pumping unit 60 preferably includes an integrated enclosure 156. The configuration of crank assembly 84 and the use of a single Pitman arm 86 enable enclosure 156 to be removably mounted on base 62 and enclose motor 76, belts 78, sheaves 80, planetary gear reducer 82, the crank assembly, and the lower end of the Pitman arm. A slot (not shown) is provided in the top of enclosure 156 to allow movement of Pitman arm 86. Enclosure 156 reduces the number of moving components on pumping unit 60 that are exposed, thereby reducing the potential for injury or damage to occur. Preferably, enclosure 156 is formed of sheet metal, but may alternatively be formed of other materials, such as plastic.

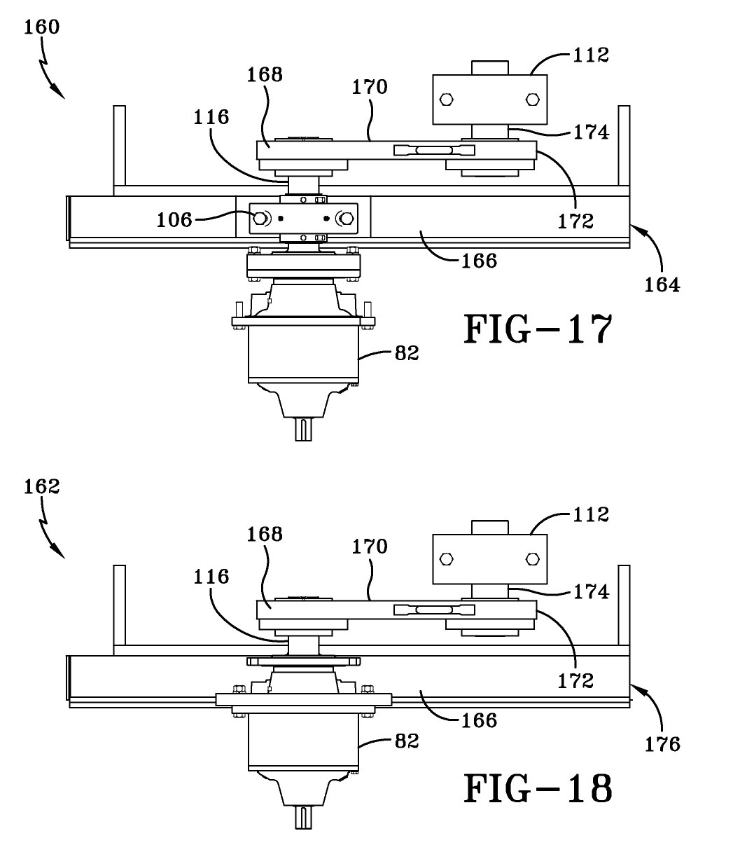

Turning now to FIGS. 17 and 18, additional exemplary embodiments of the pumping unit of the present invention are shown, with a second exemplary embodiment being indicated generally at 160 (FIG. 17), a third exemplary embodiment being indicated generally at 162 (FIG. 18). Second and third embodiment pumping units 160, 162 are generally similar in design, construction, arrangement and operation as first embodiment pumping unit 60 (FIG. 5), except as described below, and find particular usefulness in shallower or lighter-duty applications.

More particularly, second embodiment pumping unit 160 finds application with shallower oil and/or gas wells, as opposed to deeper wells that are more suitable for first embodiment pumping unit 60. Such shallower or medium-duty applications do not require the robustness found in first embodiment pumping unit 60, and in particular, may include a less robust crank assembly 164 than first embodiment crank assembly 84. For example, second embodiment pumping unit uses planetary gear reducer 82, while crank assembly 164 includes only one wall 166, to which the gear reducer is attached in a manner similar to that as described above for first embodiment pumping unit 60. Pillow block bearing 106 is mounted on wall 166, and the bearing is connected to a first end 168 of a single crank arm 170 via shaft 116. A second end 172 of crank arm 170 is connected to a shaft 174 that supports central pillow block bearing 112. Single Pitman arm 86 (FIG. 6) is rigidly attached to central pillow block bearing 112. This construction of crank assembly 164 of second embodiment pumping unit 160 is sufficient for medium-duty pumping, while being cost efficient by reducing the number of components when compared to first embodiment pumping unit 60.

Third embodiment pumping unit 162 is even more cost efficient than second embodiment pumping unit 160, and finds application with oil and/or gas wells that are shallower than those that employ second embodiment pumping unit 160. For such shallow or light-duty applications, crank assembly 176 is similar to second embodiment crank assembly 164, but does not require pillow block bearing 106. As a result, planetary gear reducer 82 connects to first end 168 of single crank arm 170 via shaft 116 without pillow block bearing 106. Second end 172 of crank arm 170 is connected to shaft 174, which supports central pillow block bearing 112, and single Pitman arm 86 is attached to the central pillow block bearing. By eliminating bearing 106, this construction of crank assembly 176 of third embodiment pumping unit 162 is sufficient for light-duty pumping, while being extremely cost efficient.

In this manner, pumping unit 60, 160, 162 of the present invention provides a simplified, efficient and cost effective design with a single Pitman arm 86 connected to crank assembly 84, 164, 176. Crank assembly 84, 164, 176 is a simple, heavy-built crank system that supports the loads of walking beam 68 and beam weight pack 72, and converts the rotational motion of the crank into reciprocating motion at horse head 70, while being independent of gear reducer 82. In addition, because gear reducer 82 is of a planetary design and is located to the side of crank assembly 84, 164, 176, the gear reducer is only used for rotating the crank assembly and is not subject to the heavy loads of walking beam 68 and weight pack 72, and thus may be an economical and commercially available reducer.

Pumping unit 60, 160, 162 of the present invention also provides a crank assembly 84, 164, 176 that is capable of being positively locked in position to secure walking beam 68, weight pack 72, Pitman arm 86, crank arms 108A, 108B, 170, and the rod string without any disassembly of these components when it is necessary to service the gear reducer. Moreover, because gear reducer 82 is mounted on one side of crank assembly 84, 164, 176 and is commercially available, the gear reducer is safer to service and can be replaced quickly, easily and economically. Planetary gear reducer 82 includes a deeper gear reduction ratio than the prior art, which desirably yields a stroke speed as low as about 4 spm, and is capable of attaining higher stroke speeds.

Pumping unit 60, 160, 162 of the present invention provides commercially available pillow block bearings 66, 88, 106, 112 that are economical to use and replace. Pumping unit 60, 160, 162 also provides trolley 74 or low friction strip 180, each one of which enables easy adjustment of the position of weight pack 72 and easy securing of the weight pack in a balanced position on walking beam 68. Pumping unit 60, 160, 162 includes an automatic belt tensioning system with the use of hinged motor platform 142, and enables declutching and/or disengagement of belts 78 to stop horse head 70 at a desired position, or to change the belts. The use of a single Pitman arm 86 and crank assembly 84, 164, 176 that are enclosed by integrated enclosure 156 reduces the number of moving components of pumping unit 60, 160, 162 which are exposed, thereby increasing the safety of the pumping unit.

It is to be understood that pumping unit 60, 160, 162 of the present invention may be used in any type of oil and/or gas well pumping system, including systems other than those shown and described above, without affecting the overall concept or operation of the invention. In addition, the design and/or construction of components of pumping unit 60, 160, 162 may be adjusted for particular design requirements without affecting the concept or operation of the invention. For example, motor 76 may be an electric motor or internal combustion engine, and different configurations for crank assembly 84, 164, 176 and/or bearings 68, 88, 106, 112 may be employed without affecting the concept or operation of the invention.

Accordingly, the improved pumping unit is simplified, provides an effective, safe, inexpensive, and efficient structure which achieves all the enumerated objectives, provides for eliminating difficulties encountered with prior art pumping units, and solves problems and obtains new results in the art.

In the foregoing description, certain terms have been used for brevity, clarity and understanding; but no unnecessary limitations are to be implied therefrom beyond the requirements of the prior art, because such terms are used for descriptive purposes and are intended to be broadly construed. Moreover, the present invention has been described with reference to exemplary embodiments. It shall be understood that this illustration is by way of example and not by way of limitation, as the scope of the invention is not limited to the exact details shown or described. Potential modifications and alterations will occur to others upon a reading and understanding of this disclosure, and it is understood that the invention includes all such modifications and alterations and equivalents thereof.

Having now described the features, discoveries and principles of the invention, the manner in which the improved pumping unit is constructed, arranged and used, the characteristics of the construction and arrangement, and the advantageous, new and useful results obtained; the new and useful structures, devices, elements, arrangements, parts and combinations are set forth in the appended claims.

What is claimed is:

1. A pumping unit for removing fluid from a well, said pumping unit comprising:
a base disposed adjacent said well;
a plurality of support posts mounted on said base, said support posts extending upwardly and being connected to a center bearing;
a walking beam pivotally mounted on said center bearing;
a single Pitman arm pivotally connected to said walking beam rearwardly of said center bearing, said Pitman arm extending downwardly from said walking beam;
a crank assembly mounted on said base generally centrally beneath and operatively connected to said Pitman arm;
a gear reducer mounted on and operatively connected to said crank assembly; and
a drive unit mounted on said base and being operatively connected to said gear reducer, whereby actuation of said drive unit actuates motion of the gear reducer, said crank assembly and said Pitman arm, thereby actuating pivotal movement of said walking beam to pump said fluid from said well.

2. The pumping unit of claim 1, wherein said crank assembly includes:
at least one wall mounted on said pumping unit base, said gear reducer being operatively mounted on said at least one wall; and
at least one crank arm extending generally parallel to said base, said crank arm including a first end that is operatively connected to an output shaft of said gear reducer, the crank arm further including a second end that is operatively connected to said Pitman arm.

3. The pumping unit of claim 2, wherein said crank assembly includes two walls and two crank arms, said two crank arms being disposed between said walls.

4. The pumping unit of claim 2, wherein said operative connection between said crank arm first end and said output shaft of said gear reducer includes a pillow block bearing.

5. The pumping unit of claim 2, wherein said wherein said operative connection between said crank arm second end and said Pitman arm includes a pillow block bearing.

6. The pumping unit of claim 2, wherein said at least one wall is formed with an opening and said at least one crank arm includes a locking eye that is selectively alignable with said opening, and wherein the opening and locking eye accept a lock down bar when said opening and locking eye are in alignment.

7. The pumping unit of claim 1, wherein said gear reducer is mounted on a side of said crank assembly.

8. The pumping unit of claim 1, wherein said gear reducer is a planetary gear reducer.

9. The pumping unit of claim 1, further comprising an adjustable weight system mounted on a rearward end of said walking beam, said adjustable weight system comprising:
a trolley frame disposed on a rearward end of said walking beam;
a plurality of roller bearings, said roller bearings being disposed between said walking beam and said trolley frame, the roller bearings enabling selective movement of the trolley frame along the walking beam;
at least one counterbalance weight mounted on said trolley frame; and
an adjustment screw, said adjustment screw being operatively connected to said trolley frame and to said walking beam, whereby adjustment of said screw provides control of said selective movement of the trolley frame along the walking beam.

10. The pumping unit of claim 1, further comprising an adjustable weight system mounted on a rearward end of said walking beam, said adjustable weight system comprising:
a strip of low friction material secured to a top surface of said rearward end of said walking beam;
at least one selectively moveable counterbalance weight mounted on said rearward end of said walking beam on said strip of low friction material;
at least one non-moveable counterbalance weight mounted on said rearward end of said walking beam; and
an adjustment screw, said adjustment screw being operatively connected to said at least one moveable counterbalance weight and to said at least one non-moveable counterbalance weight, whereby adjustment of said adjustment screw provides control of said selective movement of the at least one moveable counterbalance weight along said walking beam.

11. The pumping unit of claim 1, wherein said drive unit is mounted on a hinged platform, in which a hinge point of said platform is forward of the weight of said drive unit.

12. The pumping unit of claim 11, further comprising a tensioning lever, whereby actuation of said tensioning lever moves said hinged platform, thereby enabling selective disengagement of said drive unit.

13. The pumping unit of claim 1, further comprising an enclosure removably mounted on said base, said enclosure encloses said crank assembly, said gear reducer, and said drive unit.

14. The pumping unit of claim 1, wherein said center bearing is a pillow block bearing.

15. The pumping unit of claim 1, wherein said pivotal connection of said Pitman arm to said walking beam includes a pillow block bearing.

16. A pumping unit for removing fluid from a well, said pumping unit comprising:
a base disposed adjacent said well;
a plurality of support posts mounted on said base, said support posts extending upwardly and being connected to a center bearing;
a walking beam pivotally mounted on said center bearing;
an adjustable weight system mounted on a rearward end of said walking beam;
a Pitman arm pivotally connected to said walking beam rearwardly of said center bearing, said Pitman arm extending downwardly from said walking beam;
a crank assembly mounted on said base and being operatively connected to said Pitman arm;
a gear reducer mounted on and operatively connected to said crank assembly; and
a drive unit mounted on said base and being operatively connected to said gear reducer, whereby actuation of said drive unit actuates motion of the gear reducer, said crank assembly and said Pitman arm, thereby actuating pivotal movement of said walking beam to pump said fluid from said well.

17. The pumping unit of claim 16, wherein said adjustable weight system includes:
a trolley frame disposed on a rearward end of said walking beam;
a plurality of roller bearings, said roller bearings being disposed between said walking beam and said trolley frame, the roller bearings enabling selective movement of the trolley frame along the walking beam;
at least one counterbalance weight mounted on said trolley frame; and
an adjustment screw, said adjustment screw being operatively connected to said trolley frame and to said walking beam, whereby adjustment of said screw provides control of said selective movement of the trolley frame along the walking beam.

18. The pumping unit of claim 16, wherein said adjustable weight system includes:
a strip of low friction material secured to a top surface of said rearward end of said walking beam;
at least one selectively moveable counterbalance weight mounted on said rearward end of said walking beam on said strip of low friction material;
at least one non-moveable counterbalance weight mounted on said rearward end of said walking beam; and
an adjustment screw, said adjustment screw being operatively connected to said at least one moveable counterbalance weight and to said at least one non-moveable counterbalance weight, whereby adjustment of said adjustment screw provides control of said selective movement of the at least one moveable counterbalance weight along said walking beam.

19. A pumping unit for removing fluid from a well, said pumping unit comprising:
a base disposed adjacent said well;
a plurality of support posts mounted on said base, said support posts extending upwardly and being connected to a center bearing;
a walking beam pivotally mounted on said center bearing;
a Pitman arm pivotally connected to said walking beam rearwardly of said center bearing, said Pitman arm extending downwardly from said walking beam;
a crank assembly mounted on said base and being operatively connected to said Pitman arm;
a gear reducer mounted on and operatively connected to said crank assembly; and
a drive unit being operatively connected to said gear reducer, said drive unit being mounted on a hinged platform, said hinged platform being mounted on said base and including a hinge point forward of the weight of said drive unit, whereby actuation of said drive unit actuates motion of the gear reducer, said crank assembly and said Pitman arm, thereby actuating pivotal movement of said walking beam to pump said fluid from said well.

20. The pumping unit of claim 19, further comprising a tensioning lever, whereby actuation of said tensioning lever moves said hinged platform, thereby enabling selective disengagement of said drive unit.
